(19) United States
(12) Patent Application Publication
(10) Pub. No.: US 2007/0189781 A1
(43) Pub. Date: Aug. 16, 2007

(54) Consumable cartridge for image forming apparatus and image forming apparatus

(75) Inventors: Syuichi Katogi, Toyokawa-shi (JP); Hiroshi Mizuno, Aisai-shi (JP); Hiromasa Ueno, Toyohashi-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/598,686

(22) Filed: Nov. 14, 2006

(30) Foreign Application Priority Data
Feb. 14, 2006 (JP) 2006-036355

(51) Int. Cl. G03G 15/00

(52) U.S. Cl. 399/12

(57) ABSTRACT

A toner cartridge for a printer includes a species detection key which forms a part of an outer shape of the cartridge and an IC chip which stores individual information, wherein a part of a harness for connecting to the IC chip or between the IC chip and a connector portion is mounted on the species detection key. A main body of the printer has a key receiving portion which mates with the species detection key. Thereby, the printer can detect erroneous attachment of a cartridge at early stage and surely cope with various types of cartridges requiring only compact space with the aid of its detection means.

### CROSS-REFERENCE TO RELATED APPLICATIONS

This application is based upon and claims the benefit of priority from the prior Japanese Patent Application No. 2006-036355 filed on Feb. 14, 2006, the entire contents of which are incorporated herein by reference.

### BACKGROUND OF THE INVENTION

1. Field of the Invention

The present invention relates to an image forming apparatus and a consumable cartridge removably attached to main body of the image forming apparatus. More particularly, it relates to a consumable cartridge for an image forming apparatus and an image forming apparatus capable of preventing erroneous attachment of a cartridge when replacing and mechanical troubles due to the erroneous attachment.

2. Description of the Related Art

With respect to an electro-photographic type image forming apparatus such as copier, printer, and the like, a process cartridge including a photosensitive body, a toner cartridge for housing toner, and the like are removably attached thereto. Those kinds of cartridges are generally consumable and need changing timely. Except for a case of an apparatus of which maintenance and check is always done by a technical service person, a user changes consumable cartridges of the apparatus by himself or herself. Since a non expert user carries out this operation, there may sometimes occur a case that a wrong cartridge is attached or a cartridge is attached in erroneous way. Therefore, there has been devised a combination of a cartridge and a main body to which the cartridge is attached wherein attachment portions of the cartridge and the main body have physical convexo-concave shape portions to mate with each other. That is, in the case where the convexo-concave shape portions of the cartridge and the main body do not mate with each other, the cartridge cannot be attached to the main body. However, such convexo-concave shape design requires space and is hard to be sorted into various types.

On the other hand, Japanese unexamined patent publication No. 5-249777 discloses an image forming apparatus of which cartridge has a fuse so as to detect whether or not the cartridge is a new one by inspecting electrical conductivity of the fuse. Furthermore, as to this image forming apparatus, the cartridge also has a resistor thereby cartridge type or the like is detected by its resistance. Furthermore, Japanese unexamined patent publication No. 2002-169428 discloses an image forming apparatus of which cartridge has memory means such as IC (integrated circuit) chip thereby a main body of the image forming apparatus can read contents stored in the IC chip. According to this publication, employment of the memory means makes it possible to cope with various types of cartridges more easily with less space in comparison with convexo-concave design.

However, with respect to the above-mentioned conventional image forming apparatuses, detection of a resistance of the resistor and readout of contents in the memory means cannot be carried out until a cartridge is thoroughly put into the apparatus, the cover of the apparatus is closed, and power of the main body is turned on. Therefore, if an erroneous attachment is detected, it is required to turn off power, and open the cover again to take out the cartridge. This is problematic because it takes time to detect erroneous attachment and to redo attaching with an appropriate one in comparison with the convexo-concave shape design of which erroneous attachment is detected instantly when trying to attach.

On the other hand, the convexo-concave shape design is not preferable in terms of creating more varieties due to restriction of space, molding accuracy, and the like. What is more, in the case a convex portion of the convexo-concave design gets fractured or broken apart, for example, the cartridge can be put inside regardless of a shape of a concave portion. From this point, erroneous attachment of a cartridge sometimes cannot be detected by relying on the convexo-concave design only. Accordingly, there has been required precaution against coming off or breakage of convex portions.

### SUMMARY OF THE INVENTION

The present invention has been attempted to solve the above-noted problems involved in the conventional consumable cartridges and image forming apparatuses. Thus, an object of the invention is to provide a consumable cartridge for an image forming apparatus and an image forming apparatus capable of detecting erroneous attachment of a cartridge at early stage and surely coping with various types of cartridge design requiring compact space with the aid of its detection means.

To achieve the above object of the present invention, there is provided a consumable cartridge housing consumable stuff for an image forming apparatus and used with attached to the image forming apparatus, the consumable cartridge comprising: a species detection shape portion which forms a part of an outer shape of the consumable cartridge; and a storage medium which stores identifying information, wherein the storage medium or an access path to the storage medium is mounted on the species detection shape portion at least partially.

The inventive consumable cartridge for an image forming apparatus comprises a species detection shape portion and a storage medium. Since the species detection shape portion forms a part of the outer shape of the cartridge, a cartridge with an inappropriate outer shape cannot be attached to the image forming apparatus. Accordingly, erroneous attachment is detected by the outer shape at early stage. Furthermore, since a storage medium is provided, it is possible to cope with various types of cartridges only requiring compact space. Still further, since the storage medium or the access path to the storage medium is mounted on the species detection shape portion at least partially, exchange of information with the storage medium is made impossible in the case the species detection shape portion gets broken apart. Accordingly, there is provided a consumable cartridge for an image forming apparatus capable of surely detecting erroneous attachment. It is to be noted that the access path mentioned herein includes a connection terminal for connecting the storage medium and the image forming apparatus and wiring between the storage medium and the connection terminal.

Furthermore, there is provided an inventive image forming apparatus used with attaching a consumable cartridge housing consumable stuff therein, wherein the consumable cartridge comprises: a species detection shape portion which forms a part of an outer shape of the consumable cartridge; and a storage medium which stores identifying information, wherein the storage medium or an access path to the storage medium is mounted on the species detection shape portion at least partially. Since the inventive image forming apparatus is used with the consumable cartridge which comprises the species detection shape portion and the storage medium, erroneous attachment of a consumable cartridge is detected for sure.

The inventive consumable cartridge for an image forming apparatus and the inventive image forming apparatus make it possible to detect erroneous attachment of a cartridge at early stage, to cope with various types of cartridges requiring only compact space, and to detect right or wrong of a cartridge for sure.

### BRIEF DESCRIPTION OF THE DRAWINGS

These and other objects and advantages of this invention will become more fully apparent from the following detailed description taken with the accompanying drawings in which:

FIG. 1 is a cross sectional view showing schematic structure of a printer directed to a first embodiment;

FIG. 2 is a perspective view showing schematic structure of a toner cartridge and its attaching portion;

FIG. 3 is a schematic perspective view showing one of variations of species detection form for a toner cartridge;

FIG. 4 is a schematic perspective view showing other variation of species detection form for a toner cartridge;

FIG. 5 is a cross sectional view showing schematic structure of a printer directed to a second embodiment;

FIG. 6 is a perspective view showing schematic structure of a consumable cartridge directed to the second embodiment;

FIG. 7 is a perspective view showing schematic structure of another consumable cartridge directed to the second embodiment;

FIG. 8 is a diagram showing an angle that the consumable cartridge of the second embodiment and a main body form;

FIG. 9 is a cross sectional view showing schematic structure of a printer directed to a third embodiment;

FIG. 10 is a perspective view showing schematic structure of a toner cartridge directed to the third embodiment;

FIG. 11 is another cross sectional view showing schematic structure of the printer directed to the third embodiment;

FIG. 12 is a cross sectional view showing schematic structure of a consumable cartridge directed to a fourth embodiment;

FIG. 13 is a cross sectional view showing schematic structure of another consumable cartridge directed to the fourth embodiment;

FIG. 14 is a perspective view showing other example way to apply an IC chip; and

FIG. 15 is a perspective view showing other example way to apply an IC chip.

### DETAILED DESCRIPTION OF THE PREFERRED EMBODIMENT

Preferred embodiments of the present invention will be described in detail below with reference to the accompanying drawings. The preferred embodiments apply the present invention to an image forming apparatus such as copier, printer, and the like and to a consumable cartridge such as toner cartridge to be attached to the image forming apparatus.

### First Embodiment

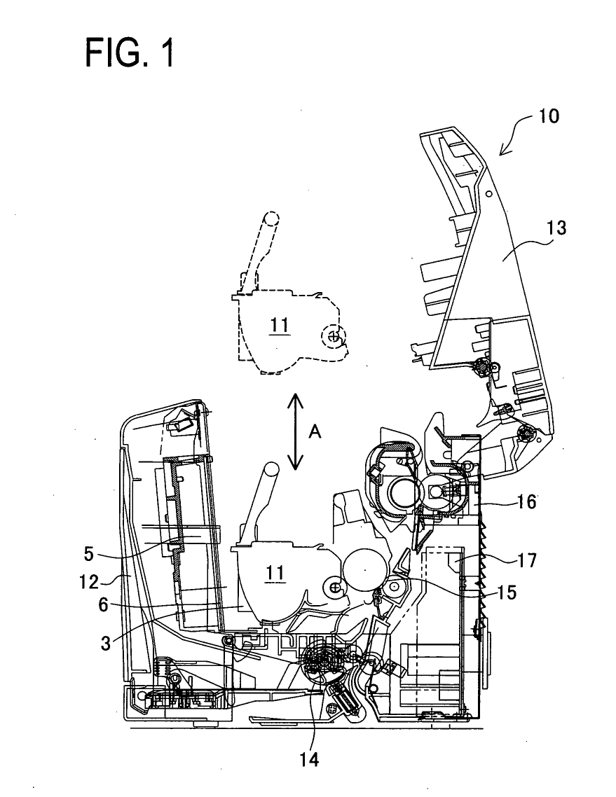

As shown in FIG. 1, a printer 10 of a first embodiment is a compact monochrome printer with a toner cartridge 11 being attached there removably. The printer 10 has a cover 13 which is a roof-type one making pivotal movement to a main body 12. When the cover 13 is opened upward, attachment and detachment of the toner cartridge 11 can be carried out in arrow-A directions. In this embodiment, the toner cartridge 11 corresponds to a consumable cartridge.

The printer 10 further includes a paper feeding portion 14, an image forming portion 15, a fixing portion 16, and the like for image formation. Furthermore, the printer 10 also includes a controller 17 for controlling respective portions. Upon a user's instruction, a toner image is formed by the image forming portion 15 on transfer paper fed by the paper feeding portion 14, and fixed on the paper by the fixing portion 16. Then, a sheet of transfer paper on which the toner image has been fixed is ejected. In the course of image formation, toner housed in the toner cartridge 11 is consumed by the image forming portion 15 and amount of housed toner decreases gradually. When housed toner runs out, the toner cartridge 11 needs changing. Structure of respective portions relating to image forming operation is similar to an ordinary apparatus and descriptions in this matter is therefore omitted.

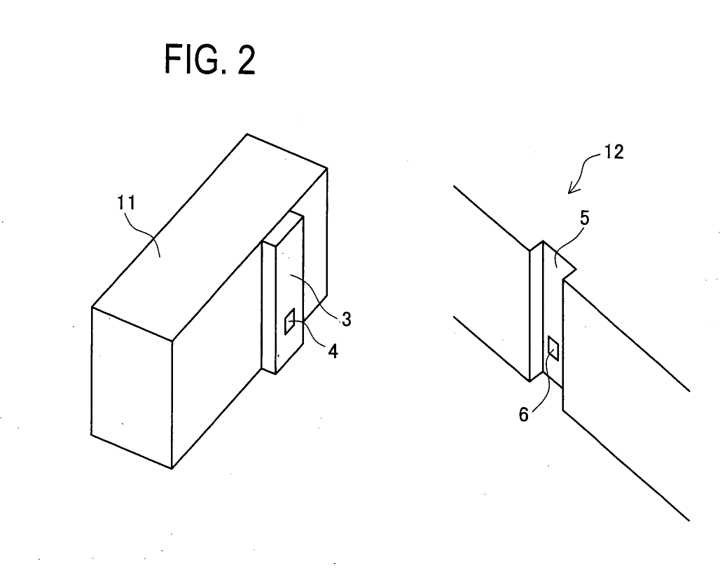

FIG. 2 shows schematic structure of a consumable cartridge such as like the toner cartridge 11. For concise explanation, a shape of the toner cartridge 11 in FIG. 2 is drawn more simply than the actual. There is provided a species detection key 3, a physical convex shaped portion, on a part of a certain face of the toner cartridge 11. Furthermore, an IC chip 4 is provided on a convex face of the species detection key 3. Further on, a key receiving portion 5 is formed at a position of the main body 12 where a toner cartridge 11 is to be fitted in. The key receiving portion 5 is a concave shaped portion which mates with the shape of the species detection key 3. Furthermore, inside of the concave portion of the key receiving portion 5, there is provided a chip connector portion 6 to be electrically connected to the IC chip 4 of the toner cartridge 11. As described hereafter, erroneous attachment of a toner cartridge 11 to a main body 12 is physically detected from combination of their species detection key 3 and key receiving portion 5 at first. Further, erroneous attachment is detected in detail by connection of an IC chip 4 and a chip connector portion 6.

Alternatively, a key receiving portion 5 may be provided separately from a chip connector portion 6. For example, as to the toner cartridge 11 shown in FIG. 1, the species detection key 3 is provided at a side portion in the diagram and the key receiving portion 5 is provided at a corresponding halfway portion of a path to insert the toner cartridge 11 into the main body 12. Therefore, physical mating check of the species detection key 3 and the key receiving portion 5 is made halfway through inserting operation. When the toner cartridge 11 clears the physical mating check and is thoroughly inserted into the main body 12, the IC chip 4 and the chip connector portion 6 come to electrically connectable. Alternatively, the species detection key 3 and the key receiving portion 5 may be arranged at positions where they just mate with each other when the toner cartridge 11 is inserted to end.

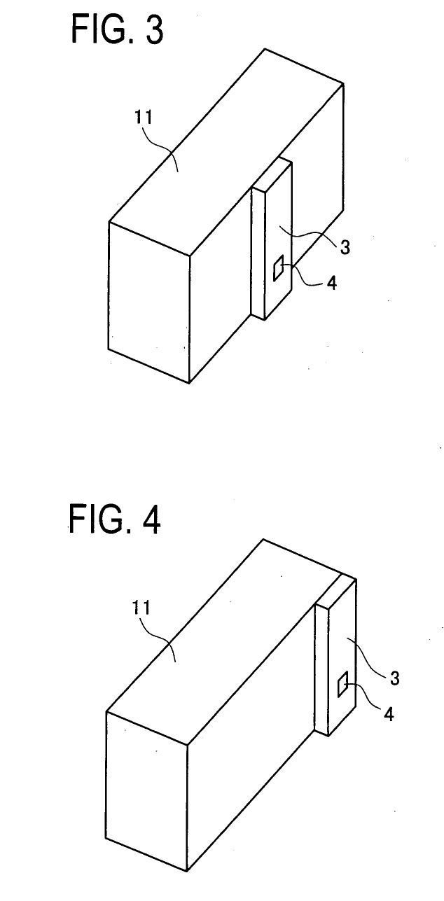

Size and positioning of the key receiving portion 5 provided on the main body 12 of the printer 10 differs depending on species of the printer 10 and the like. Also, on a toner cartridge 11 to be attached in each printer 10, there is formed a species detection key 3 of which size and positioning differs depending on species and the like. Therefore, as to a toner cartridge 11 of which species does not agree with that of the main body 12, its species detection key 3 comes to contact with a portion not corresponding to a key receiving portion 5 and cannot be attached appropriately. FIGS. 3 and 4 show variations of the toner cartridge 11 in which positioning of the species detection key 3 is different. Not only positioning but also shape, size, and the like of the species detection key 3 can be different.

An IC chip 4 attached on a toner cartridge 11 stores individual information of the toner cartridge 11. The individual information means a serial number, virginity information to show the toner cartridge 11 has not yet been used, species information to identify species of the toner cartridge 11 in detail, color information of toner color housed therein, accumulative printed sheet number information to check out amount of residual toner, and the like, for example. Actually, out of the above information, necessary information are selected and stored in an IC chip 4. Once being connected to a chip connector portion 6 in a main body 12, an IC chip 4 can exchange information with a controller 17 in the main body 12.

That is, the controller 17 can read information stored in the IC chip 4. Furthermore, the controller 17 can write new information in the IC chip 4, as well. The IC chip 4 has a read-only area and a rewritable area, and information needless to rewrite (serial number, species information, color information, and the like) are stored in the read-only area whereas information which will be rewritten (virginity information, accumulative printed sheet number information, and the like) are stored in the rewritable area. Of the IC chip 4, virginity information, accumulative printed sheet number information, and the like are overwritten by the controller 17 depending on toner using state of the toner cartridge 11. For example, once the toner cartridge 11 begins to be used, virginity information is deleted and number of printed sheet is added along execution of printing.

As to the printer 10, when toner housed in the toner cartridge 11 decreases and change timing comes, the controller 17 indicates it with its display or the like to give a user to alarm for coming of toner empty. Finding the alarm, the user prepares a new toner cartridge 11 to change with the old one. In the case a user tries to attach a toner cartridge 11 of which species detection key 3 does not fit in the key receiving portion 5, the species detection key 3 is not accepted by the key receiving portion 5 properly, then. Therefore, erroneous attachment can surely be prevented at early stage.

Furthermore, as to the printer 10, in the case a toner cartridge 11 of which species detection key 3 properly fits in the key receiving portion 5 is attached, more particular detection is made in accordance with contents stored in the IC chip 4. On condition that the toner cartridge 11 is attached, the cover 13 is closed, and power of the main body 12 is turned on, the chip connector portion 6 and the IC chip 4 are electrically connected. Then, individual information stored in the IC chip 4 is read by the controller 17. Thereby, the controller 17 can detect whether or not it is an appropriate toner cartridge 11 relying on the individual information read out.

For example, in the case accumulative printed sheet number information exceeds a predetermined number, it is detected that residual toner is little. In the case virginity information lacks or accumulative printed sheet number information is not zero, it is detected that a non-virgin toner cartridge 11 has been attached. In such cases, the controller 17 copes with operation in accordance with individual information stored in the IC chip 4. In the case detected as inappropriate toner cartridge 11, this fact is indicated on a display or the like of the main body 12 and image formation operation will not be executed. For example, in the cases of disagreement of species information, detection of no residual toner, and the like, image formation operation will not be executed. In the case detected as not virgin but still usable, this fact is indicated on the display to notify a user and image formation operation is executed.

The printer 10 can cope with a case that a toner cartridge 11 of which species detection key 3, a convex-shaped portion, is broken apart is attached thereto. Since there is no striking portion, the toner cartridge 11 with its species detection key 3 broken apart can be attached even if it had an improper species detection key 3. However, even though the cover 13 is closed and power is turned on under such situation, an IC chip 4 is not arranged on the position corresponding to a chip connector portion 6. Therefore, the controller 17 cannot read individual information. Thereby, the controller 17 can detect that the toner cartridge 11 attached therein is not an appropriate one. Consequently, in this case, this fact is indicated on the display or the like of the main body 12 and image forming operation is not executed.

As described, of the printer 10 directed to the first embodiment, the main body 12 has the key receiving portion 5 and the chip connector portion 6, and the toner cartridge 11 has the species detection key 3 and the IC chip 4, whereby it is detected whether or not that is an appropriate toner cartridge by the above items. That is, since rough detection is made by mating of the species detection key 3 and the key receiving portion 5, erroneous attachment is detected upon trying to attach it. Furthermore, since individual information is obtained from contents stored in the IC chip 4, more specific state of the toner cartridge 11 is detected. Furthermore, a breakage in a species detection key 3 is detected from presence or absence of an IC chip 4. Therefore, the printer 10 can detect erroneous attachment at early stage and surely cope with various species requiring only compact space with the aid of its detection means. As variations of the first embodiment, an IC chip itself may be built in a species detection key 3 and a connection terminal for the IC chip may be arranged at the position indicated as “4” in FIG. 2 through FIG. 4. Furthermore, the outer form for the exterior packaging of the IC chip 4 may be used as species detection key 3.

### Second Embodiment

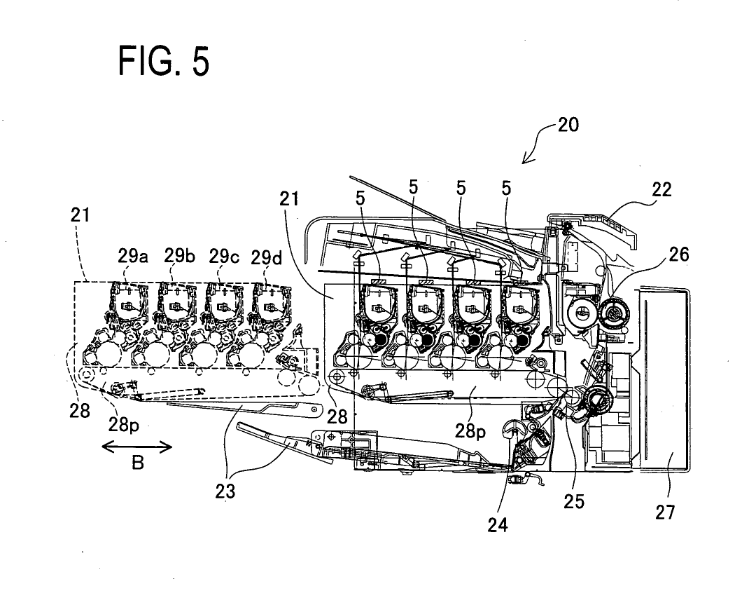

Next, there will be described a second embodiment. As shown in FIG. 5, as to a color printer 20 of the second embodiment, a consumable cartridge 21 is attached to and detached from a main body 22 in arrow-B directions. The consumable cartridge 21 includes four colors of toner cartridges and a printing unit in a unified form. The color printer 20 has a roof-type cover 23 making pivotal movement to the main body 22. When the cover 23 is opened downward, attachment and detachment of the consumable cartridge 21 can be carried out. Similar to the first embodiment, the color printer 20 includes a paper feeding portion 24, an image forming portion 25, a fixing portion 26, and the like for image formation, and controller 27 for controlling respective portions.

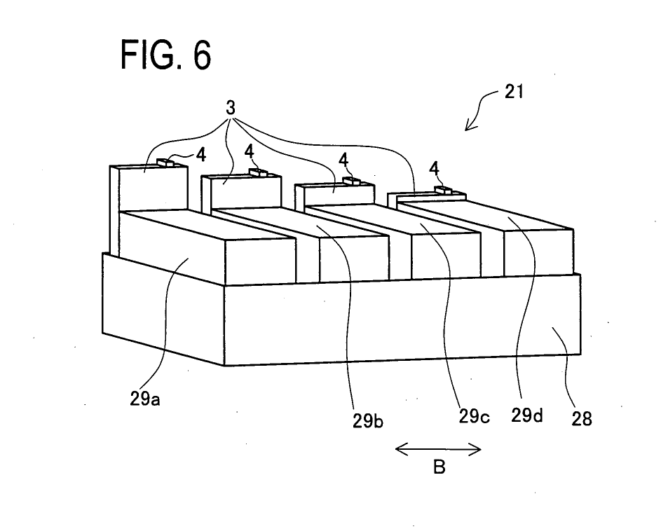

As schematically shown in FIG. 6, the consumable cartridge 21 is structured by arranging toner cartridges 29a, 29b, 29c, and 29d of each color in a cartridge case 28. Shapes of the cartridges are simplified in comparison with an actual one, also in FIG. 6. An intermediate transfer belt 28p is incorporated in the cartridge case 28, as shown in FIG. 5.

As shown in FIG. 6, the toner cartridges 29a, 29b, 29c, and 29d for each color have species detection keys 3 at their rear-side end portions, respectively. Furthermore, IC chips 4 are mounted on top faces of the respective species detection keys 3, in FIG. 6. In this embodiment, each of the species detection keys 3 is a plate-like convex portion and, in FIG. 6, heights of the plate-like convex portions differ by color. More specifically, height of the convex portion becomes higher stepwise from right to left as to the case of FIG. 6. Since each IC chip 4 is mounted on a top face of each species detection key 3, positions in height of IC chips 4 differ by color.

On the other hand, as shown in FIG. 5, the main body 22 has four key receiving portions 5 of which height positions differ by color. A chip connector section 6 is mounted on each key receiving portion 5. Positioning of each chip connector portion 6 is made to meet with a position of each IC chip 4 when the consumable cartridge 21 is attached. As indicated with arrow-B in both FIGS. 5 and 6, the consumable cartridge 21 is attached and detached along direction where the toner cartridges 29a, 29b, 29c, and 29d for each color are arranged. Therefore, when attaching and detaching the consumable cartridge 21, each of the species detection keys 3 follows about same tracks. When attached, the consumable cartridge 21 goes rightward in FIG. 6 and the shortest species detection key 3 firstly goes into the main body 22.

As to the color printer 20 of the second embodiment, when change timing of either each color of a toner cartridge or the printing unit comes, the controller 27 indicates this fact on its display or the like so as to urge the user to change. Finding the message to change, the user prepares a necessary part for changing, opens the cover 23, and takes out the consumable cartridge 21. After that, the user detaches the part to be changed, replaces with a new one, and attaches the consumable cartridge 21 again to the main body 22.

In the case a species detection key 3 and a key receiving portion 5 do not mate with each other, the consumable cartridge 21 cannot be attached appropriately. Especially, in the case a species detection key 3 is too large or position of it is improper, the species detection key 3 come to contact with the main body 22 on the way of attachment insertion, whereby erroneous attachment can be detected instantly. Furthermore, in the case a species detection key 3 is too small or gets broken apart, an IC chip 4 for the species detection key 3 and a chip connector portion 6 cannot be connected appropriately, whereby the controller 27 detects the cartridge as inappropriate one. Even though an IC chip 4 and a chip connector portion 6 can be connected somehow, image formation operation is not executed as long as individual information is inappropriate.

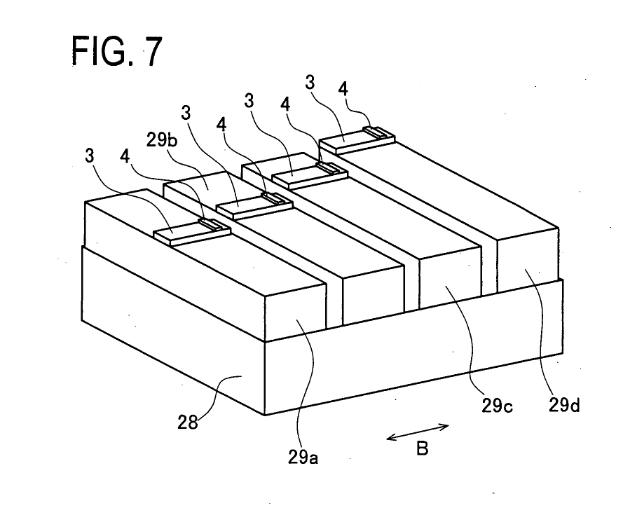

As described, the color printer 20 of the second embodiment also can detect erroneous attachment at early stage and surely cope with various types of cartridges requiring only compact space with the aid of its detection means. Additionally, in the present embodiment, convexo-concave shaped portions may be arranged between each adjoining space of the toner cartridges 29a through 29d and the cartridge case 28 so as to prevent erroneous insertion of the toner cartridges to the cartridge case 28. Furthermore, as shown in FIG. 7, instead of the species detection keys 3 each of which height is made different, there may be arranged species detection keys 3 on top faces or side faces of respective toner cartridges 29a, 29b, 29c, and 29d with respectively different positioning or size.

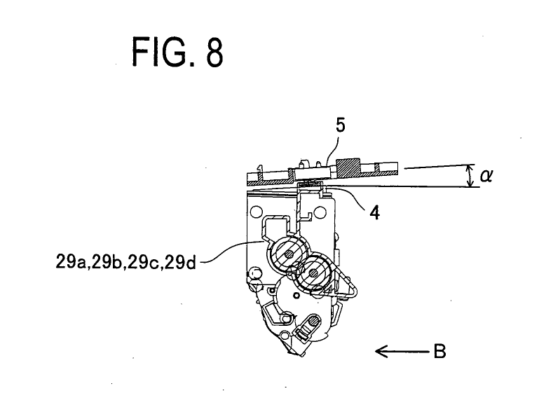

Furthermore, in the case an attachment face of the IC chip 4 and attaching/detaching direction of the consumable cartridge 21 are substantially parallel like the color printer 20 of the present embodiment, the attachment face of the IC chip 4 is preferably arranged slightly slantwise. Here, the above situation means a case that the attachment face of the IC chip 4 is provided at any one of positions, i.e., top, bottom, left, or right side of attachment direction but not ahead of the attachment direction. The one of positions, i.e., top, bottom, left, or right side herein is at lateral side with reference to frontward direction and may be anywhere within a rage of 360 degrees. In this case, as shown in FIG. 8, the key receiving portion 5 is formed slightly slantwise with reference to insertion direction of the consumable cartridge 21. In FIG. 8, the key receiving portion 5 is tilted in frontward direction (arrow-B) by degree a. Thereby, the IC chip 4 and the chip connector portion 6 can surely be connected to each other. Furthermore, the IC chip 4 may be provided slightly slantwise with reference to insertion direction. Furthermore, the second embodiment may be structured such that an IC chip itself is built in a species detection key 3 and a corresponding connection terminal or the like is provided at a position indicated as “4” in FIG. 8 slightly slantwise, also.

### Third Embodiment

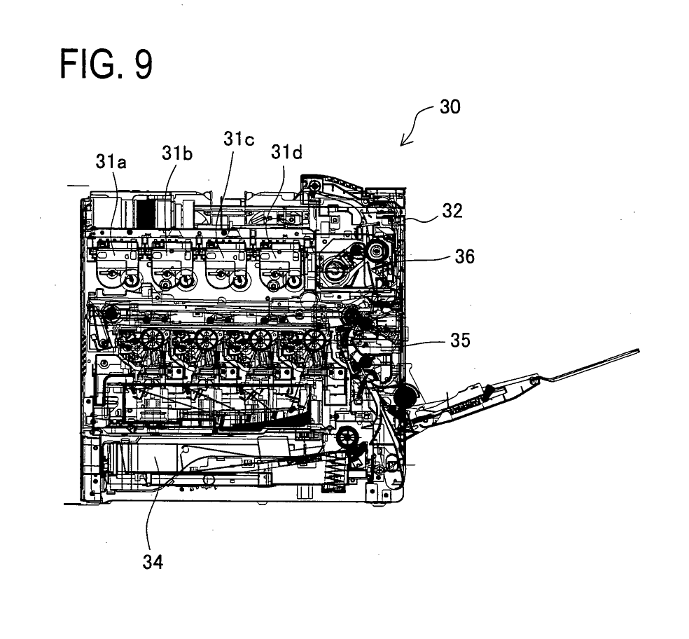

Next, there will be described a third embodiment. As shown in FIG. 9, as to a color printer 30 of a third embodiment, four colors of toner cartridges 31a, 31b, 31c, and 31d are separately attached to and detached from a main body 32. Although not shown in FIG. 9, there is arranged a cover making pivotal movement to the main body 32 toward a user's side. When the cover is opened, the toner cartridges 31a, 31b, 31c, and 31d can be inserted in backward direction and pulled out frontward direction in FIG. 9. Similar to the first and second embodiments, the color printer 30 includes a paper feeding portion 34, an image forming portion 35, a fixing portion 36, and the like for image formation, and a controller for controlling respective portions.

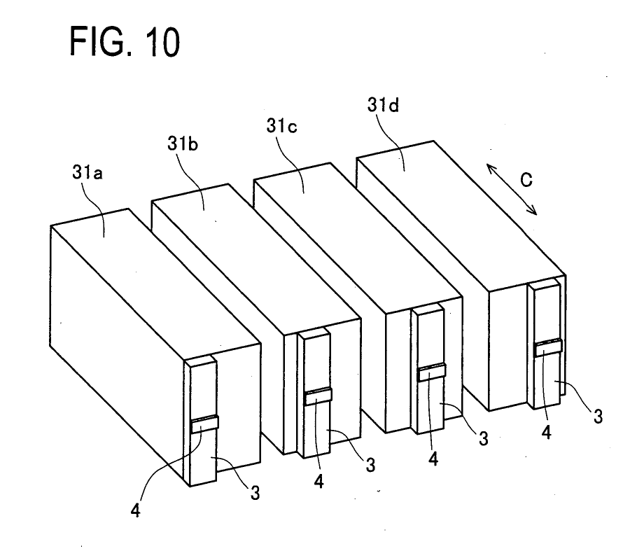

As schematically shown in FIG. 10, a species detection key 3 for each of the toner cartridges 31a, 31b, 31c, and 31d, is provided at front-side end viewable from a user to insert the cartridge. In FIG. 10 also, shapes of the toner cartridges 31a, 31b, 31c, and 31d are simplified in comparison with the actual ones. Each of the species detection keys 3 are provided at a longitudinally different position with reference to a front face of each of the toner cartridges 31a, 31b, 31c, and 31d. Furthermore, there is provided an IC chip 4 on a convex portion of each species detection key 3 (front face in FIG. 10). Arrow-C in FIG. 10 indicates attachment and detachment direction for each of the toner cartridges 31a, 31b, 31c, and 31d.

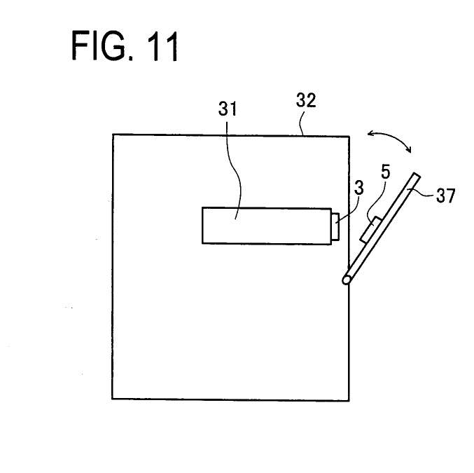

As FIG. 11 shows it in simplified manner, the main body 32 of the color printer 30 has a cover 37. FIG. 11 is a schematic cross sectional view of the color printer 30 of FIG. 9 viewed from its left side. Inside of the cover 37, there are formed key receiving portions 5 each of which has a concave portion mating with corresponding species detection key 3. Four of the key receiving portions 5 are formed on backward face of the cover 37 and each of them mates with each species detection key 3 of the toner cartridges 31a, 31b, 31c, and 31d. Therefore, when each of the toner cartridges 31a, 31b, 31c, and 31d is attached and the cover 37 is closed, each species detection key 3 and each corresponding key receiving portion 5 mate with each other. In the case of erroneous insertion of a cartridge, the cover 37 does not normally close, whereby the error can be detected instantly. Furthermore, when the cover 37 closes normally, a chip connector portion 6 provided inside of the key receptor portion 5 and the IC chip 4 are designed to be connected to each other.

Therefore, the color printer 30 of the third embodiment also can detect erroneous attachment at early stage and surely cope with various types of cartridges requiring only compact space with the aid of its detection means. As a variation of the third embodiment, an IC chip itself may be built in a species detection key 3 and a connection terminal or the like for the IC chip may be arranged at the positions indicated as “4” in FIG. 10.

### Fourth Embodiment

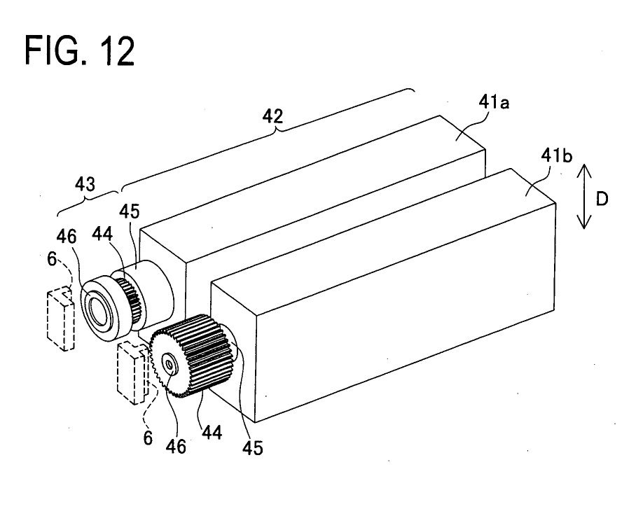

Next, a fourth embodiment will be described. As shown in FIG. 12, consumable cartridges 41a and 41b of the fourth embodiment have a toner housing portion 42 and a driving force receiving portion 43 as their units respectively. The consumable cartridges 41a and 41b are individually attached to and detached from the main body in arrow-D direction in FIG. 12. Although FIG. 12 shows only two consumable cartridges 41a and 41b, cartridges for four colors can be applied to the fourth embodiment, similar to the other embodiments.

On each of the driving force receiving portions 43, a cylindrical shaped species detection key 45 and an annular IC chip connecting terminal 46 are formed coaxially to a driven gear 44. The driven gears 44 get driving force from the main body when the consumable cartridges 41a and 41b are attached to the main body. By the driving force, the entirety of the driving force receiving portions 43 rotates as one.

In the fourth embodiment, species detection keys 45 for each of the consumable cartridges 41a and 41b are shaft members different in diameter. Shaft receiving members different in diameter are provided on main body and work as key receiving portions. Consequently, a species detection key 45 of which diameter is larger than that of a key receiving portion cannot be attached there. Although the respective species detection keys 45 in FIG. 12 are indicated as fixed diametric shaft members, their shaft diameter may be changed at halfway of the shafts. For example, shaft diameter may change step-wise. Such shaped shafts can detect more various species of consumable cartridges.

Furthermore, IC chip connecting terminals 46 are designed to be annular terminals different in diameter. The main body has chip connector portions 6 at respectively corresponding portions. Individual information cannot be obtained from a consumable cartridge of which contact point does not meet with that of the main body. An IC chip connecting terminal 46 can be used as a species detection key. Furthermore, a driven gear 44 may also perform a role of a species detection key 45 or a part of the role. In the case a shape of a driven gear 44 does not mate with a driving force transmitter of the main body, the consumable cartridge with the driven gear 44 cannot be attached there or driving force cannot be transmitted.

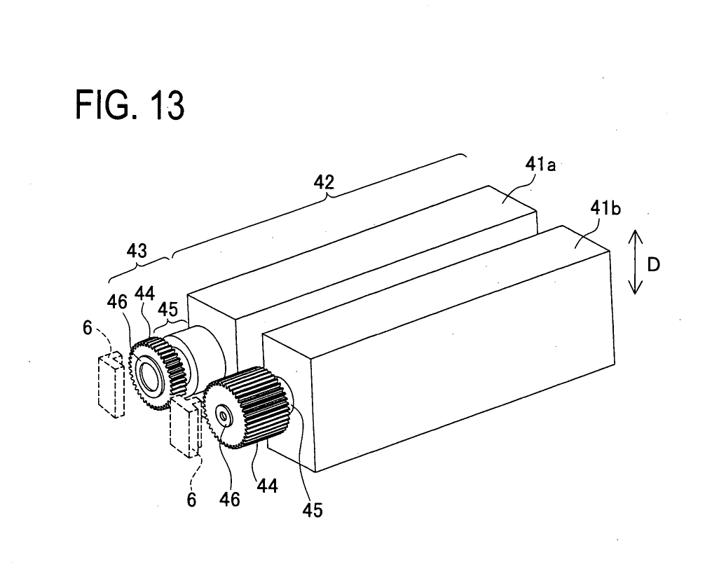

Therefore, the consumable cartridges 41a and 41b of the fourth embodiment also can detect erroneous attachment at early stage and surely cope with various types of cartridges requiring only compact space with the aid of its detection means. As to the consumable cartridges 41a and 41b of the present embodiment, it is acceptable that an IC chip itself is not directly mounted on a species detection key 45. That is, both an IC chip and a species detection key 45 are included in a driving force receiving portion 43 and unified as a whole. Although the driven gears 44 in FIG. 12 are drawn as two gears different in diameter, they may be same in their diameter as shown in FIG. 13. Furthermore, as long as physical detection can be made satisfactorily by species detection keys 45, IC chip connecting terminals 46 may be same in their diameter. Additionally, an IC chip itself may be included in an IC chip connecting terminal 46.

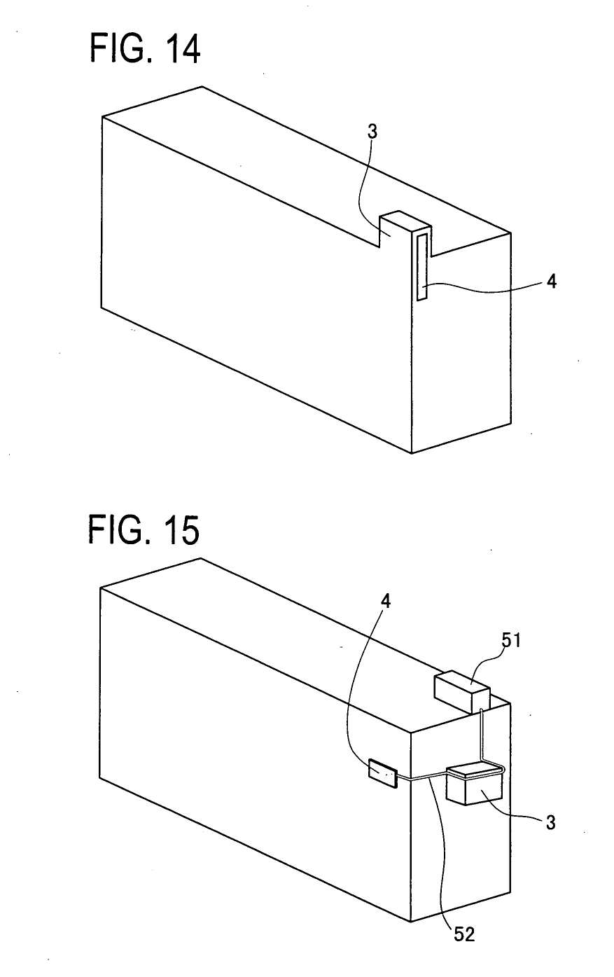

Furthermore, for each of the mentioned embodiments, an IC chip 4 may be united in a species detection key 3 to some extent. That is, the entirety of the IC chip 4 does not need being mounted on a convex face of the species detection key 3. For example, it may be arranged on a side face of a species detection key 3. Furthermore, as shown in FIG. 14, the one that an IC chip 4 is partially mounted on a species detection key 3 is applicable. Alternatively, the one that two or more IC chips 4 are included and one of them is mounted on a species detection key 3 is also applicable. Furthermore, for example, it is also applicable that a connecting portion 51 to be connected with a chip connector portion 6 is arranged separately from an IC chip 4 and a harness 52 for connecting the connecting portion 51 and the IC chip 4 is mounted on a species detection key 3, as shown in FIG. 15. That is, it is applicable as long as at least a portion of an IC chip 4 and an access path (including a connecting portion 51 and a harness 52) are mounted on a species detection key 3. For any of the above cases, it is applicable as long as electrical connection between an IC chip 4 and a chip connector portion 6 is made impossible when a species detection key 3 gets broken apart or an inappropriate cartridge is attached forcibly.

The embodiments were described above merely as illustrative examples, but it is nothing to limit the invention in any way. Therefore, the invention can obviously be improved or modified in various ways without deviating from its essentials. For instance, a consumable cartridge to be applied to any of the above embodiments may be a toner cartridge, an ink cartridge, a photo sensitive body cartridge, a waste toner cartridge, a staple needle cartridge, and the like, whatever consumable.

That is, the inventive consumable cartridge houses consumable stuff for an image forming apparatus and is used with attached to the image forming apparatus, and the consumable cartridge comprises: a species detection shape portion which forms a part of an outer shape of the consumable cartridge; and a storage medium which stores identifying information, wherein the storage medium or an access path to the storage medium is mounted on the species detection shape portion at least partially. Also, the inventive image forming apparatus is used with attaching a consumable cartridge housing consumable stuff therein, and uses the above mentioned inventive consumable cartridge.

Furthermore, as to the present invention, it is preferable that the storage medium is built in the species detection shape portion. Alternatively, a part of the storage medium may be mounted on the species detection shape portion. In either case, access to the storage medium is made impossible when the species detection shape portion gets broken apart.

Further alternatively, the inventive consumable cartridge may comprise a connection terminal for connecting the storage medium to an image forming apparatus and the connection terminal may be mounted on the species detection shape portion. Or, the consumable cartridge may comprise a connection terminal for connecting the storage medium to an image forming apparatus and a wiring for connecting the storage medium and the connection terminal, and the wiring may be mounted on the species detection shape portion at least partially. Access to the storage medium is thus made impossible when the species detection shape portion gets broken apart.

Alternatively, in the invention, it is preferable that the species detection shape portion includes a driving force transmitting portion for receiving mechanical driving force from the image forming apparatus. With such mechanism, a cartridge of which species detection shape portion does not mate cannot be driven mechanically.

Furthermore, in the invention, it is preferable that the species detection shape portion is arranged on whichever side of top, bottom, left, or right with reference to attaching direction to the image forming apparatus, and slantwise toward attaching direction to the image forming apparatus. Suppose that the species detection shape portion tilts in attaching direction of the cartridge, the storage medium or the access path provided thereon tilts together, whereby connection to an image forming apparatus is made for sure.

Furthermore, in the invention, it is also preferable that the species detection shape portion mates with a mating portion of the image forming apparatus halfway of an attaching path to the image forming apparatus. With such structure, a cartridge of which species detection shape does not mate cannot be attached.

Furthermore, in the invention, it is preferable that a mating portion to mate with the species shape portion is provided at an attachment-target portion to which the consumable cartridge is attached or on halfway of an attachment path through which the consumable cartridge is attached. With the structure, mating check is made easily between the species detection shape portion of the consumable cartridge and the mating portion of the image forming apparatus.

Furthermore, in the invention, it is preferable that the consumable cartridge includes a connection terminal which connects the storage medium to the main body of the image forming apparatus and is mounted on the species detection shape portion, and wherein a matching terminal to be contact with the connection terminal is provided on the mating portion. With the structure, a connection terminal of a consumable cartridge and a matching terminal of an image forming apparatus are connected only when a species detection shape portion and a mating portion just mate with each other. Therefore, accurate detection can be made.

What is claimed is:

1. A consumable cartridge housing consumable stuff for an image forming apparatus and used with attached to the image forming apparatus, the consumable cartridge comprising:
a species detection shape portion which forms a part of an outer shape of the consumable cartridge; and
a storage medium which stores identifying information,
wherein the storage medium or an access path to the storage medium is mounted on the species detection shape portion at least partially.

2. The consumable cartridge for the image forming apparatus according to claim 1,
wherein the storage medium is built in the species detection shape portion.

3. The consumable cartridge for the image forming apparatus according to claim 1,
wherein a part of the storage medium is mounted on the species detection shape portion.

4. The consumable cartridge for the image forming apparatus according to claim 1
further comprising a connection terminal for connecting the storage medium to a connection target apparatus, wherein the connection terminal is mounted on the species detection shape portion.

5. The consumable cartridge for the image forming apparatus according to claim 1 further comprising:
a connection terminal for connecting the storage medium to a connection target apparatus; and
a wiring for connecting the storage medium and the connection terminal,
wherein the wiring is mounted on the species detection shape portion at least partially.

6. The consumable cartridge for the image forming apparatus according to claim 1,
wherein the species detection shape portion includes a driving force transmitting portion for transmitting mechanical driving force with a connection target apparatus.

7. The consumable cartridge for the image forming apparatus according to claim 1, wherein the species detection shape portion is
arranged on whichever side of top, bottom, left, or right with reference to attaching direction to the connection target apparatus, and
slantwise toward attaching direction to the connection target apparatus.

8. The consumable cartridge for the image forming apparatus according to claim 1,
wherein the species detection shape portion mates with a mating portion of the connection target apparatus halfway of an attaching path to a connection target apparatus.

9. An image forming apparatus used with attaching a consumable cartridge housing consumable stuff therein, wherein the consumable cartridge comprises:
a species detection shape portion which forms a part of an outer shape of the consumable cartridge; and
a storage medium which stores identifying information,
wherein the storage medium or an access path to the storage medium is mounted on the species detection shape portion at least partially.

10. The image forming apparatus according to claim 9,
wherein a mating portion which mates with the species detection shape portion is provided at an attachment-target portion to which the consumable cartridge is attached.

11. The image forming apparatus according to claim 9,
wherein a mating portion which mates with the species detection shape portion is provided on halfway of an attachment path through which the consumable cartridge is attached.

12. The image forming apparatus according to claim 10,
wherein the consumable cartridge includes a connection terminal which connects the storage medium to the main body of the image forming apparatus and is mounted on the species detection shape portion,
and wherein a matching terminal to be contact with the connection terminal is provided on the mating portion.

13. The image forming apparatus according to claim 11,
wherein the consumable cartridge includes a connection terminal which connects the storage medium to the main body of the image forming apparatus and is mounted on the species detection shape portion,
and wherein a matching terminal to be contact with the connection terminal is provided on the mating portion.

14. The image forming apparatus according to claim 9, wherein the storage medium is built in the species detection shape portion.

15. The image forming apparatus according to claim 9, wherein a part of the storage medium is mounted on the species detection shape portion.

16. The image forming apparatus according to claim 9,
wherein the consumable cartridge further comprises a connection terminal for connecting the storage medium to the main body of the image forming apparatus and
wherein the connection terminal is mounted on the species detection shape portion.

17. The image forming apparatus according to claim 9,
wherein the consumable cartridge further comprises a connection terminal for connecting the storage medium to the main body of the image forming apparatus and
a wiring for connecting the storage medium and the connection terminal, and
wherein the wiring is mounted on the species detection shape portion at least partially.

18. The image forming apparatus according to claim 9,
wherein the species detection shape portion includes a driving force transmitting portion for transmitting mechanical driving force with the main body of the image forming apparatus.

19. The image forming apparatus according to claim 9, wherein the species detection shape portion is
arranged on whichever side of top, bottom, left, or right of the consumable cartridge with reference to attaching direction to the image forming apparatus, and
slantwise toward attaching direction to the image forming apparatus.

20. The image forming apparatus according to claim 9,
wherein the species detection shape portion mates with a mating portion of the image forming apparatus halfway of an attaching path of the consumable cartridge to the image forming apparatus.
